(19) United States
(12) Patent Application Publication
(10) Pub. No.: US 2004/0196400 A1
(43) Pub. Date: Oct. 7, 2004

(54) Digital camera user interface using hand gestures

(76) Inventors: Donald J. Stavely, Windsor, CO (US); Amy E. Battles, Windsor, CO (US); Amol S. Pandit, Greeley, CO (US); Robert F. Yockey, Fort Collins, CO (US); Miles K. Thorland, Fort Collins, CO (US); Daniel J. Byrne, Fort Collins, CO (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/408,619

(22) Filed: Apr. 7, 2003

(51) Int. Cl. H04N 5/222

(52) U.S. Cl. 348/333.01

(57) ABSTRACT

Control methods, a digital camera and a digital camera user interface that respond to arm, hand and/or finger gestures. The digital camera recognizes the arm, hand and/or finger gestures as inputs to its user interface and responds to implement predetermined tasks or operations.

### TECHNICAL FIELD

The present invention relates generally to digital cameras and methods, and more specifically, to control methods, digital cameras and digital camera user interfaces that responds to hand gestures and method of using same.

### BACKGROUND

Portable devices such as cell phones, digital cameras, game devices, and Personal Digital Assistants (PDA's) need some form of user input device(s) for controlling their functions. This is especially true as these appliances have more sophisticated functions, and more capable graphic displays.

Digital cameras currently use a number of buttons for input. In many ways, using buttons to navigate a complex graphical user interface has proven clumsy and unnatural. Also, as cameras get smaller and more capable, it is difficult to find room for a large number of buttons that are typically needed.

Docks are becoming a popular method of interfacing digital cameras to personal computers and televisions, and the like. Docks also provide charging for batteries. Unfortunately, interacting with the camera's keypad while it is docked is very awkward and unnatural.

What is needed is a user input method for digital cameras that is more flexible and capable than buttons, and can be used when docked.

U.S. Pat. No. 6,421,453 entitled “Apparatus and methods for user recognition employing behavioral passwords” discloses a “method for controlling access of an individual to one of a computer and a service and a facility comprises the steps of: pre-storing a predefined sequence of intentional gestures performed by the individual during an enrollment session; extracting the predefined sequence of intentional gestures from the individual during a recognition session; and comparing the pre-stored sequence of intentional gestures to the extracted sequence of intentional gestures to recognize the individual.”

U.S. Pat. No. 6,421,453 also discloses an example wherein “a PDA or a digital wallet implements a combination of sound and gesture recognition to verify an authorized user. In such a case, a behavioral password consists of the tapping sounds generated when an authorized user taps the PDA or wallet in a predefined sequence. Moreover, the finger gestures associated with the tapping sequence are sensed by a touch pad (or other means). If a higher degree of accuracy is desired in the recognition process, the user's fingerprints may also be extracted while he is tapping.”

U.S. Pat. No. 6,115,482 entitled “Voice-output reading system with gesture-based navigation” discloses an “optical-input print reading device with voice output for people with impaired or no vision in which the user provides input to the system from hand gestures. Images of the text to be read, on which the user performs finger- and hand-based gestural commands, are input to a computer, which decodes the text images into their symbolic meanings through optical character recognition, and further tracks the location and movement of the hand and fingers in order to interpret the gestural movements into their command meaning. In order to allow the user to select text and align printed material, feedback is provided to the user through audible and tactile means. Through a speech synthesizer, the text is spoken audibly. For users with residual vision, visual feedback of magnified and image enhanced text is provided. Multiple cameras of the same or different field of view can improve performance. In addition, alternative device configurations allow portable operation, including the use of cameras located on worn platforms, such as eyeglasses, or on a fingertip system. The use of gestural commands is natural, allowing for rapid training and ease of use. The device also has application as an aid in learning to read, and for data input and image capture for home and business uses.”

U.S. Pat. No. 6,377,296 entitled “Virtual map system and method for tracking objects” discloses a “system, for automatically tracking objects, including a computer processor and memory, cameras and other sensors and a user interface. A user registers an object with the system by presenting the object to a camera, which produces an image of the object, and describing the object through a user interface. Based on an analysis of the image and the description provided by the user, an object identifier/tracker determines the attributes of the object, classifies the object according to the attributes, and indexes and stores the image in a database. The system will thereafter track the location of the object. Subsequently, the user can query the system to search the database to obtain information regarding the object.”

U.S. Pat. No. 6,377,296 discloses that “A gesture recognition system accepts input from a user based on the user's movements, such as hand gestures. That is, the user communicates with the system in a manner similar to a sign language. U.S. patent application Ser. No. 09/079,754 for Apparatus and Methods for User Recognition Employing Behavioral Passwords describes a gesture recognition system.” U.S. patent application Ser. No. 09/079,754 corresponds to U.S. Pat. No. 6,421,453 discussed above.

It is an objective of the present invention to provide for an improved digital camera and digital camera user interface that responds to hand gestures and method of using same.

### SUMMARY OF THE INVENTION

To accomplish the above and other objectives, the present invention provides for control methods along with a digital camera and a digital camera user interface that responds to hand gestures. The digital camera recognizes and responds to hand or finger gestures, for example, as inputs to its user interface.

The present invention uses the digital camera itself to look at the user. The digital camera comprises a motion detection algorithm or hand gesture recognition algorithm that recognizes the user's movements, such as hand or finger gestures, and responds appropriately.

At a larger distance, such as with the digital camera disposed in a dock on top of a television, for example, the digital camera looks for and responds to hand or arm motion. For example, a right-to-left waving motion may mean to scroll to the next picture.

When the digital camera is being held in the user's hand, it responds to finger motion in front of the lens. For example, as the user holds the camera facing a display, left or right finger motion may invoke different functions. Finger motion may also be used to move a cursor on the display.

One exemplary function is to control the display of images which where previously captured and stored in the camera. A right-to-left motion of the user's hand may scroll to the next image, while a left-to-right motion may scroll to the previous image. This creates a convenient and intuitive way to navigate or scroll through images. Alternatively, if a menu of items or functions is displayed for selection, the user may move a highlight or cursor through the appropriate hand motion.

True object recognition is not required to implement this invention. Only coarse boundary and motion detection is needed, depending of the sophistication of the user interface. The system may also be trained by the user, in the manner of “scribble” handwriting recognition algorithms on PDA's. This improves the accuracy and minimize any “false triggers” of the user interface.

### BRIEF DESCRIPTION OF THE DRAWINGS

The various features and advantages of embodiments of the present invention may be more readily understood with reference to the following detailed description taken in conjunction with the accompanying drawings, wherein like reference numerals designate like structural elements, and in which:

FIGS. 1a and 1b are front and back views, respectively, that illustrate an exemplary embodiment of a digital camera and digital camera user interface in accordance with the principles of the present invention;

FIG. 2 illustrates operation of the exemplary digital camera and digital camera user interface; and

FIG. 3 is a flow diagram that illustrates an exemplary control method in accordance with the principles of the present invention.

### DETAILED DESCRIPTION

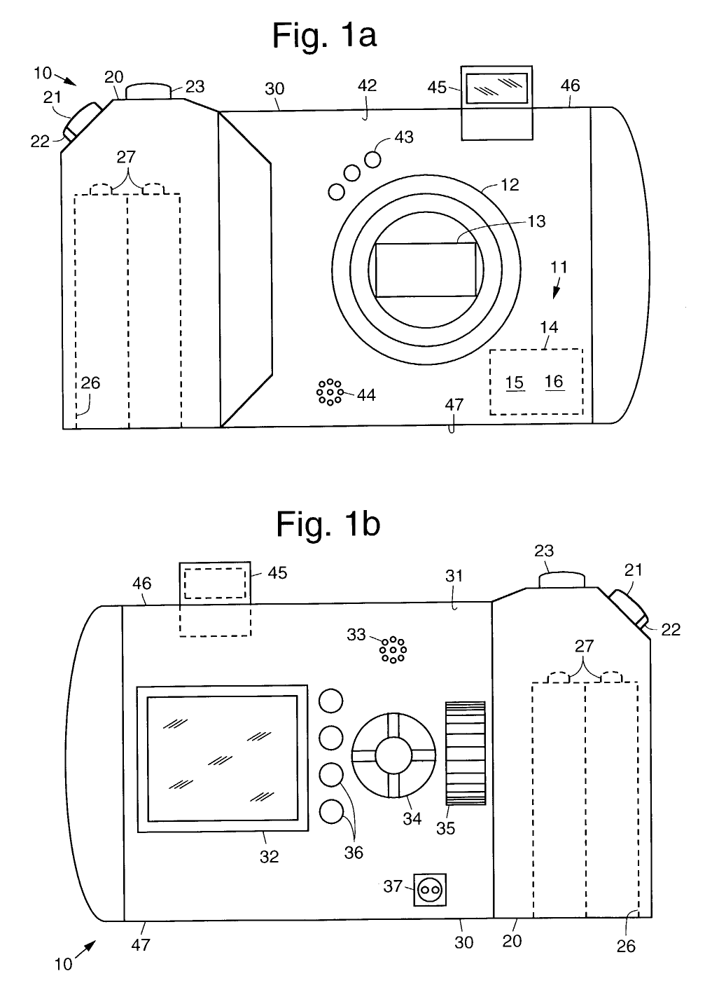

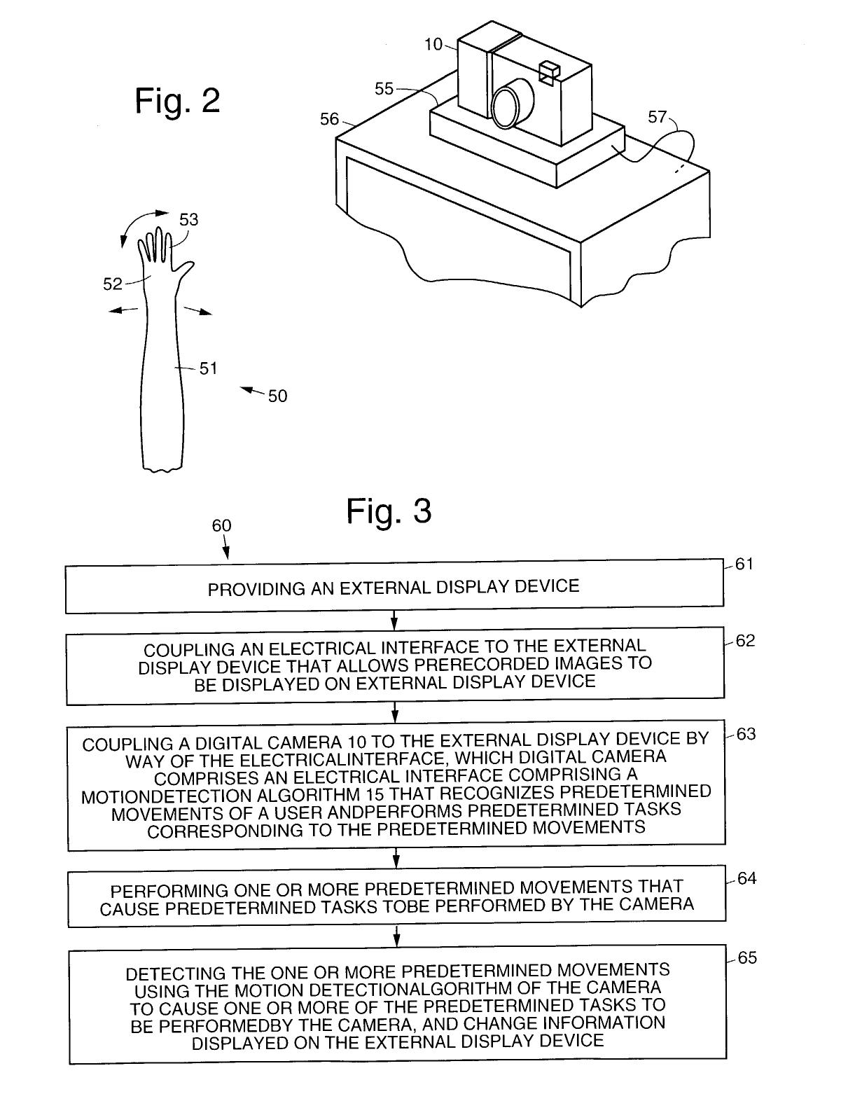

Referring to the drawing figures, FIGS. 1a and 1b are front and back views, respectively, that illustrate an exemplary embodiment of a digital camera 10 and digital camera user interface 11 (generally designated) in accordance with the principles of the present invention. FIG. 2 illustrates operation of the exemplary digital camera 10 and digital camera user interface 11.

The exemplary digital camera 10 comprises a handgrip section 20 and a body section 30. The handgrip section 20 includes a power button 21 having a lock latch 22, a record button 23, and a battery compartment 26 for housing batteries 27. A metering element 43 and microphone 44 are disposed on a front surface 42 of the digital camera 10. A pop-up flash 45 is located adjacent the top surface 46 of the digital camera 10.

The digital camera 10 comprises a lens 12, or imaging optics 12, and an image sensor 13 for receiving images transmitted by the imaging optics 12. A processor 14 is coupled to the image sensor 13 that implements the user interface 11. The processor 14 comprises a motion detection, or hand gesture recognition, algorithm 15 that recognizes predetermined movements made by a user 50 (generally designated), such as movement of the user's arm 51 and/or hand 52, shown in FIG. 2, and performs predetermined tasks corresponding to the predetermined movements.

A rear surface 31 of the exemplary digital camera 10 includes a liquid crystal display (LCD) 32, a rear microphone 33, a joystick pad 34, a zoom control dial 35, a plurality of buttons 36 for setting functions of the camera 10 and an output port 37 for downloading images to an external display device 56 (FIG. 2), or a computer, for example.

The imaging optics 12 and image sensor 13 image and detect motion of a user's arm 51, hand 52, or finger 53 (FIG. 2). Output signals of the image sensor 13 are processed by the motion detection, or hand gesture recognition, algorithm 15 and detects selected gestures or motion that corresponds to commands or tasks that are to be performed.

The motion detection, or hand gesture recognition, algorithm 15 may be implemented using techniques described in U.S. Pat. No. 6,115,482 entitled “Voice-output reading system with gesture-based navigation” or U.S. Pat. No. 6,421,453 entitled “Apparatus and Methods for User Recognition Employing Behavioral Passwords, for exmaple. The contents of these patents is incorported herein by reference in their entirety.

In operation, the digital camera 10 recognizes and responds to hand or finger gestures as inputs to its user interface. The digital camera 10 views the user 50. The motion detection algorithm or hand gesture recognition algorithm recognizes the user's movements, such as arm 51, hand 52 or finger 53 gestures, for example, and responds appropriately.

At longer distance, s is illustrated in FIG. 2, such as when the digital camera 10 is disposed in a dock 55 on top of a television 56, or external display device 56, for example, that are coupled together by way of a cable 57, the digital camera 10 looks for and responds to hand 52 or arm 51 motion. For example, a right-to-left waving motion may mean (is programmed) to scroll to the next picture.

As is illustrated in FIG. 2, when the digital camera is being held in the user's hand 52, it responds to motion of the user's hand 52, arm 51 or finger 53 in front of the lens 12. For example, as the user 50 holds the camera 10 facing the external display device 56, such that the user is viewing the built-in display, the lens is typically facing away from the user. In this case, left or right finger motion in front of the lens may invoke different functions. Finger or hand motion may also be used to move a cursor on the external display device 56 by appropriately programming and/or training the motion detection, or hand gesture recognition, algorithm 15. The motion detection, or hand gesture recognition, algorithm 15 would thus include a training algorithm 16.

Note that in the two cases described above, the directions of motion are reversed. When the camera is facing the user, as when the camera is disposed in the dock, the camera sees left-to-right user motion as right-to-left, and vice versa. When the camera is facing away from the user as when the user is holding the camera to view its built-in dispay, left-to-right hand or finger motion is seen by the camera as left-to-right, and vice vesa. The motion detection algorithm 15 may simply reverse the direction of motion by sensing when the camera is disposed in the dock. This avoids a confusing and counter-intuitive situation where a left-to-right motion of the user causes a right-to-left motion of images or functions as seen on the display, and vice versa.

True object recognition is not required to implement this invention. Only coarse boundary and motion detection is needed, depending of the sophistication of the user interface 11. The motion detection, or hand gesture recognition, algorithm 15 may also be trained by the user 50, in the manner of “scribble” handwriting recognition algorithms on PDA's. This improves the accuracy and minimize any “false triggers” of the user interface 11.

For the purposes of completeness, and referring to FIG. 3, the present invention also provides for a control method 60. An exemplary embodiment of the control method 60 comprises the following steps.

An external display device 55 is provided 61. An electrical interface 15 is coupled 62 to the external display device that allows prerecorded images to be displayed on external display device. A digital camera 10 is coupled 63 to the external display device by way of the electrical interface, which digital camera comprises an electrical interface 15 comprising a motion detection algorithm 15 that recognizes predetermined movements of a user 50 and performs predetermined tasks corresponding to the predetermined movements. One or more predetermined movements are performed 64 that cause predetermined tasks to be performed by the camera. The one or more predetermined movements are detected 65 using the motion detection algorithm of the camera to cause one or more of the predetermined tasks to be performed by the camera, and change information displayed on the external display device.

Thus, an improved digital camera and digital camera user interface that responds to hand gestures have been disclosed. It is to be understood that the above-described embodiments are merely illustrative of some of the many specific embodiments that represent applications of the principles of the present invention. Clearly, numerous and other arrangements can be readily devised by those skilled in the art without departing from the scope of the invention.

What is claimed is:

1. A digital camera comprising:
imaging optics;
an image sensor for receiving images transmitted by the imaging optics; and
a processor coupled to the image sensor that implements a user interface comprising a motion detection algorithm that recognizes predetermined movements of a user and performs predetermined tasks corresponding to the predetermined movements.

2. The digital camera recited in claim 1 wherein the motion detection algorithm detects left and right motion in the images received from the image sensor.

3. The digital camera recited in claim 1 wherein the motion detection algorithm detects up and down motion in the images received from the image sensor.

4. The digital camera recited in claim 2 wherein prerecorded images on the camera are scrolled in response to the left and right detected motion.

5. The digital camera recited in claim 2 wherein a cursor/highlight is moved on the display in response to the detected motion.

6. The digital camera recited in claim 1 wherein the processor further comprises a training algorithm for training the motion detection algorithm to identify the predetermined movements of the user.

7. A system comprising:
a digital camera comprising a user interface comprising a motion detection algorithm that recognizes predetermined movements of a user and performs predetermined tasks corresponding to the predetermined movements;
an external display device, and
an electrical interface that allows prerecorded images contained in the camera to be displayed on the external display device; and
wherein motion detected by the motion detection algorithm of the camera causes predetermined tasks to be performed by the camera, and changes information displayed on the external display device.

8. The system recited in claim 7 wherein the interface comprises a motion detection algorithm that detects left and right motion in the images.

9. The system recited in claim 8 wherein the left and right motion of the images is reinterpreted by the motion detection algorithm as left and right, respectively.

10. The system recited in claim 7 wherein the interface comprises a motion detection algorithm that detects up and down motion in the images.

11. The system recited in claim 10 wherein prerecorded images on the camera are scrolled in response to the detected up and down motion.

12. The system recited in claim 7 wherein a cursor/highlight is moved on the display in response to the detected motion.

13. The system recited in claim 7 wherein the motion detection algorithm further comprises a training algorithm for training the motion detection algorithm to identify the predetermined movements of the user.

14. A control method comprising the steps of:
providing an external display device;
coupling an electrical interface to the external display device that allows prerecorded images to be displayed on external display device;
coupling a digital camera to the external display device by way of the electrical interface, which digital camera comprises an electrical interface comprising a motion detection algorithm that recognizes predetermined movements of a user and performs predetermined tasks corresponding to the predetermined movements;
performing one or more predetermined movements that cause predetermined tasks to be performed by the camera; and
detecting the one or more predetermined movements using the motion detection algorithm of the camera to cause one or more of the predetermined tasks to be performed by the camera, and change information displayed on the external display device.

15. The method recited in claim 14 wherein the detecting step further comprises the steps of detecting left and right motion in the images processed by the motion detection algorithm and interpreting the left and right motion as left and right, respectively.

16. The method recited in claim 14 wherein the detecting step further comprises the steps of detecting up and down motion in the images processed by the motion detection algorithm and interpreting the up and down motion as up and down, respectively.

17. The method recited in claim 14 further comprising the step of scrolling through the predetermined images on the camera in response to the detected movements.

18. The method recited in claim 14 further comprising the step of moving a cursor/highlight on the display in response to the detected movements.

19. The method recited in claim 14 further comprising the step of training the motion detection algorithm to identify the predetermined movements of the user.
